(19) United States
(12) Patent Application Publication
(10) Pub. No.: US 2017/0028675 A1
(43) Pub. Date: Feb. 2, 2017

(54) HEAT RADIATING MATERIAL COMPRISING MIXED GRAPHITE

(71) Applicant: JAPAN MATEX CO., LTD., Osaka (JP)

(72) Inventors: Katsuro TSUKAMOTO, Osaka (JP); Yuzo NAKAMURA, Osaka (JP)

(21) Appl. No.: 15/047,760

(22) Filed: Feb. 19, 2016

(30) Foreign Application Priority Data
Jul. 29, 2015 (JP) 2015-150144
Dec. 21, 2015 (JP) 2015-248975

(51) Int. Cl. B32B 5/18; B32B 27/06; B32B 27/36; B32B 15/04; F28F 21/02; B32B 15/20

(52) U.S. Cl. CPC B32B 5/18; F28F 21/02; B32B 15/20; B32B 27/36; B32B 15/046; B32B 27/065; B32B 2250/02; B32B 2266/04; B32B 2307/302; B32B 2457/00

(57) ABSTRACT

Problem: A heat radiating material is provided to increase thermal conductivity in thickness direction by combining an expanded graphite and one or more kinds of thermally conductive fillers selected from a group consisting of artificial graphite, boron nitride, and milled pitch based carbon fiber, and also to enhance thermal conductivity in plane direction by sandwiching the mixture between sheet bodies. Solution: A heat radiating material consisting of a mixed graphite having a mixture of a filler and an expanded graphite, and a 10-100 micrometer thick sheet body, wherein the expanded graphite accounts for 70-95% of the entire mixed graphite, and wherein the mixed graphite and the sheet body are laminated.

### CLAIM OF PRIORITY

The present application claims the benefit of priority of Japan Patent Application Nos. JP2015-150144, filed on Jul. 29, 2015 and JP2015-248975, filed on Dec. 21, 2015, both incorporated herein by reference in their entirety.

### TECHNICAL FIELD

The present invention relates to a heat radiating material having mixed graphite, particularly a heat radiating material having a thermal conductivity in a thickness direction (Z-axis direction) improved by using a thermally-conductive filler, which used to be low with a conventional expanded graphite sheet (manufactured from natural graphite).

### BACKGROUND

The heat radiating material comprising expanded graphite sheet has been conventionally used for electric products, such as a television and a personal computer.

Patent Document 1 describes a radiator. More particularly, the document describes a heat radiating material obtained by bending into a corrugated shape a layered product having a structure in which both sides of an expanded graphite sheet are sandwiched with metallic foils.

Patent Document 2 describes a radiator and its manufacturing method. More particularly, the document describes a heat radiating material obtained by attaching to a metal plate an artificial graphite sheet and bending the expanded graphite sheet and the metal plate into a corrugated shape, wherein the expanded graphite sheet was obtained by graphitizing a high polymer film to exhibit thermal conductivity.

### Prior Art Documents

### Patent Documents

Patent Document 1: Japanese Unexamined Patent Application Publication No. 2015-046557.

Patent Document 2: Japanese Patent No. 3649150

### PROBLEMS TO BE SOLVED BY THE INVENTION

The radiators using the conventional expanded graphite sheets in the patent documents 1 and 2 have a problem that they have low thermal conductivity in their thickness directions (Z-axis direction) although they have good thermal conductivity in their plane directions (X-Y axis direction).

### SUMMARY OF THE INVENTION

The present invention aims to solve the above described problems and provides a heat radiating material having increased thermal conductivity in thickness direction by having a mixture of an expanded graphite and one or more kinds of thermally conductive fillers selected from a group consisting of artificial graphite, boron nitride, and milled pitch based carbon fiber, and also having enhanced thermal conductivity in plane direction by sandwiching the mixture between sheet bodies.

The invention in the first embodiment relates to a heat radiating material consisting of a mixed graphite having a mixture of a filler and an expanded graphite, and a 10-100 micrometer thick sheet body,
wherein the expanded graphite accounts for 70-95% of the entire mixed graphite, and
wherein the mixed graphite and the sheet body are laminated.

The invention in the second embodiment relates to the heat radiating material in the first embodiment, wherein the above-described sheet body is a polyester sheet.

The invention in the third embodiment relates to the heat radiating material in the first embodiment, wherein the above-described sheet body is an aluminum foil.

The invention in the fourth embodiment relates to the heat radiating material in the first to third embodiments, wherein the above-described filler is one or more kinds of thermally conductive fillers selected from a group consisting of artificial graphite, boron nitride, and milled pitch based carbon fiber.

The invention in the fifth embodiment relates to a heat radiating material consisting of a mixed graphite having a mixture of a filler and an expanded graphite, and a 10-100 micrometer thick sheet body,
wherein the above-described filler is one or more kinds of thermally conductive fillers selected from a group consisting of artificial graphite, boron nitride, and milled pitch based carbon fiber,
wherein the expanded graphite accounts for 70-95% of the entire mixed graphite,
wherein the mixed graphite and the sheet body are laminated, and
wherein the heat radiating material has the thermal conductivity of 3-15 W/m·K in thickness direction and 50-250 W/m·K in plane direction.

### EFFECT OF THE INVENTION

The invention in the first embodiment is a heat radiating material consisting of a mixed graphite having a mixture of a filler and an expanded graphite, and a 10-100 micrometer thick sheet body, wherein the expanded graphite accounts for 70-95% of the entire mixed graphite, wherein the mixed graphite and the sheet body are laminated, and wherein the thermal conductivity is improved by mixing the filler.

According to the invention in the second embodiment, a polyester sheet can be used as sheet bodies sandwiching the above-described mixed graphite.

According to the invention in the third embodiment, an aluminum foil can be used as sheet bodies sandwiching the mixed graphite.

The invention in the fourth embodiment is the heat radiating material according to the first to third embodiment, wherein the above-described filler is one or more kinds of thermally conductive fillers selected from a group consisting of artificial graphite, boron nitride, and milled pitch based carbon fiber.

The invention in the fifth embodiment is a heat radiating material consisting of a mixed graphite having a mixture of a filler and an expanded graphite, and a 10-100 micrometer thick sheet body, wherein the above-described filler is one or more kinds of thermally conductive fillers selected from a group consisting of artificial graphite, boron nitride, and milled pitch based carbon fiber, wherein the expanded graphite accounts for 70-95% of the entire mixed graphite, wherein the mixed graphite and the sheet body are laminated, and wherein the heat radiating material has good thermal conductivity of 3-15 W/m·K in thickness direction and 50-250 W/m·K in plane direction by having the filler.

### DETAILED DESCRIPTION OF THE INVENTION

The mixed graphite of the present invention is a mixture of an expanded graphite and a filler. The mixed graphite is such that thermal conductivity in thickness direction (Z-axis direction) is improved by including a filler, compared with the low thermal conductivity with the conventional expanded graphite sheet, and that having a mixture of the expanded graphite and the filler enables the expanded graphite to serve as a bond between filler molecules so that the mixed graphite can be extended into a sheet shape.

A plane direction means a direction parallel to a sheet plane and a thickness direction means a direction perpendicular to the sheet plane.

The expanded graphite preferably is obtained by grinding natural graphite (graphite) into grain state, then immersing it in sulfuric acid, neutralizing, cleaning, and further foaming it by heating it to high temperature.

The filler of the present invention preferably is a filling material with high thermal conductivity, and includes, but not limited to, hexagonal boron nitride and a carbon compound, for example, milled pitch based carbon fiber, boron nitride, and artificial graphite.

The artificial graphite of the present invention preferably includes the one including coke and pitch as its main ingredients, and the one obtained by heating and burning polyimide film in inert gas for graphitization.

The mixed graphite preferably is manufactured by mixing a filler with an expanded graphite made by processing the natural graphite as shown above.

The mixed graphite may also be manufactured by mixing a filler with an acid-treated graphite powder and by foaming the mixture by heating it to high temperature, wherein the acid-treated graphite powder is obtained by grinding natural graphite into grain state, then immersing it in sulfuric acid, neutralizing and cleaning it. When an artificial graphite is used as a filler, the artificial graphite will not be foamed even if the acid-treated graphite powder is mixed with the filler and heated to high temperature for foaming.

Methods of mixing the filler and the expanded graphite and mixing the acid-treated graphite powder and the filler include, but not limited to, a method of rotating and mixing them with an agitator.

A mixing ratio of the expanded graphite and the filler is preferably 8:2. Density of the mixed graphite is 0.8 to 1.5 g/cm³, and in particular, preferably 1.24 g/cm³.

There is a problem that the expanded graphite itself has low strength and thus its powders tend to disperse inside the apparatus to be used, possibly causing electric interference. This problem can be improved by sandwiching a graphite layer between two sheets. A resin sheet such as polyethylene terephthalate (PET) and a metallic foil, preferably an aluminum foil, may be used as a sheet body. A thickness of the sheet body is 10-100 μm or less, preferably 10-50 μm which is easy to fit the concave and convex of the surface of the soft expanded graphite. When the mixed graphite is sandwiched by the sheet bodies, it may be spread on the pre-laid sheet body and a further sheet body may be attached to it, or it may be rolled with a sheet body attached with an adhesive by a roller

### Example 1

Although the present invention describes an example of a method of manufacturing a heat radiating material of this invention, it is not limited to these examples.

1. Method of Manufacturing Expanded graphite

A natural graphite is ground into particles, and then immersed in a sulfuric acid, neutralized and cleaned, and also heated to a high temperature to be foamed, to manufacture an expanded graphite.

### 2. Method of Manufacturing Mixed Graphite

2% of GRANOC milled fiber made by Nippon Graphite Fiber Co., Ltd. (HC-600-15M, fiber length: 150 μm) is added to the expanded graphite as a filler, stirred while shaken in a plastic bag, and put into a metallic mold with 105 mm squares to mold a mixed graphite under a molding pressure of 7500 N (about 68 kg/cm² of surface pressure).

### 3. Method of Manufacturing Heat Radiating Material

11 μm of aluminum foil pre-processed with the adhesive is placed, the molded mixed graphite is put thereon, and an additional aluminum foil is overlaid on the mixed graphite, which is then press molded to manufacture a 250pm thick layered product.

### Example 2

The same methods are implemented as those in the Example 1 except that 5% of GRANOC milled fiber made by Nippon Graphite Fiber Co., Ltd. (HC-600-15M, fiber length: 150 μm) is mixed as a filler and that the thickness of the layered product is set to be 200 μm.

### Example 3

The same methods are implemented as those in the Example 1 except that 5% of charged boron nitride made by Denka Company Limited (GP particle size: 8.2 μm) is mixed as a filler and that the thickness of the layered product is set to be 220 μm.

### Example 4

The same methods are implemented as those in the Example 1 except that 10% of charged boron nitride made by Denka Company Limited (GP particle size: 8.2 μm) is mixed as a filler and that the thickness of the layered product is set to be 330 μm.

### Example 5

The same methods are implemented as those in the Example 1 except that 10% of SEC fine powder SGL-25 with a particle size of 20 μm made by SEC CARBON, LIMITED is mixed as a filler and that the thickness of the layered product is set to be 250 μm.

### Example 6

The same methods are implemented as those in the Example 1 except that 20% of SEC fine powder SGL-25 with a particle size of 20 μm made by SEC CARBON, LIMITED is mixed as a filler and that the thickness of the layered product is set to be 320 μm.

### Example 7

The same methods are implemented as those in the Example 1 except that 10% of SEC fine powder SGL-50 with a particle size of 50 μm made by SEC CARBON, LIMITED is mixed as a filler and that the thickness of the layered product is set to be 215 μm.

### Example 8

The same methods are implemented as those in the Example 1 except that 20% of SEC fine powder SGL-50 with a particle size of 50 μm made by SEC CARBON, LIMITED is mixed as a filler and that the thickness of the layered product is set to be 410 μm.

### Example 9.

### 1. Method of Manufacturing Mixed Graphite

An acid-treated graphite powder, obtained by immersing a natural graphite powder in a sulfuric acid and then neutralizing and cleaning, is mixed with a 20% of SEC fine powder SGL-50 with a particle size of 50 μm made by SEC CARBON, LIMITED as an artificial graphite of a filler, and heated to a high temperature to be foamed, and then put into a metallic mold with 105 mm squares to mold a mixed graphite under a molding pressure of 7500 N (about 68 kg/cm² of surface pressure).

### 2. Method of Manufacturing Heat Radiating Material

30 μm of PET sheet pre-processed with the adhesive is placed, the molded mixed graphite is put thereon, and additional 30 μm of PET sheet is overlaid on the mixed graphite, which is then press molded to manufacture a 1,560 μm thick layered product.

### Example 10

The same methods are implemented as those in the Example 9 except that 50 μm of aluminum foil is used as a heat radiating material and that the thickness of the layered product is set to be 1,600 μm.

### Comparative Examples 1-3

The Comparative Example 1 uses a 157 μm thickness of layered product obtained by lamination of an expanded graphite and PET sheet. The Comparative Example 2 uses a 300 μm thickness of layered product obtained by lamination of an expanded graphite and PET sheet. The Comparative Example 3 uses only an expanded graphite.

Each of 5 mm square of the above-mentioned Examples 1 to 10 and Comparative Examples 1 to 3 was used as a sample, and each thermal diffusivity and thermal conductivity in a thickness direction of the heat radiating material was measured and compared by ai-Phase Mobile 1u (made by ai-Phase Co., Ltd.).

TABLE
(average value of N = 3)

| | Thermal | Thermal |
|---|---|---|
| | Diffusivity | Conductivity |
| Measurement Documentation | (E−07 m²/s) | (W/m · K) |
| Example 1 | 41.8 | 3.6 |
| Example 2 | 52.0 | 4.4 |
| Example 3 | 35.6 | 3.0 |
| Example 4 | 75.4 | 6.4 |
| Example 5 | 61.6 | 5.2 |
| Example 6 | 98.5 | 8.4 |
| Example 7 | 48.5 | 4.1 |
| Example 8 | 120.0 | 10.3 |
| Example 9 | 128.0 | 10.9 |
| Example 10 | 141.7 | 12.1 |
| Comparative Example 1 | 6.07 | 0.5 |
| Comparative Example 2 | 14.1 | 1.0 |
| Comparative Example 3 | 55.8 | 4.8 |

As shown in the table, the results show higher thermal conductivity of 3.6 W/m·K in the Example 1 and 4.4 W/m·K in the Example 2 compared with that of 0.5 W/m·K in the Comparative Example 1 and that of 1.0 W/m·K in the Comparative Example 2 which are conventional heat radiating materials. The Comparative Example 3 has high thermal conductivity, but it cannot be used for a heat radiating material in practice since powders of the expanded graphite disperse inside the apparatus used and cause electric interference. Also, from the results of 4.4 W/m·K in the Example 2 compared with 3.6 W/m·K in the Example 1, the more filler is mixed, the higher the thermal conductivity increases. Further, the results show much higher thermal conductivity of 10.9 W/m·K and 12.1 W/m·K in Examples 9 and 10, respectively, where an acid-treated graphite powder of a natural graphite powder is mixed with an artificial graphite and then foamed, compared with the Comparative Examples. This may be because adhesiveness of the expanded graphite and the artificial graphite was increased by the foaming of the graphite powder after mixed with the artificial graphite. Moreover, the heat radiating material of this invention has higher thermal diffusivity compared with the conventional one. The results show higher values of 41.8 E-07m²/s in the Example 1 and 52.8 E-07m²/s in the Example 2 compared with 6.07E-07m²/s in the Comparative Example 1 and 14.1E-07m²/s in the Comparative Example 2. And the results show much higher thermal diffusivity of 128.0 E-07m²/s and 141.7 E-07m²/s in the Examples 9 and 10, respectively, compared with the Comparative Examples.

### INDUSTRIAL APPLICABILITY

Since the mixed graphite of the present invention has high thermal conductivity in Z axis direction and X-Y axis direction, it may be used not only as a heat radiating material but also as a thermal conductor depending on thinness of an apparatus used. For example, a mixed graphite which is sandwiched by resin sheets or metallic foils having high thermal conductivity in a surface direction can be used for a thick apparatus such as a computer, since it is arranged between overlapped fin and CPU. A mixed graphite which is laminated with metallic foils, especially aluminum foil, having high thermal conductivity in X-Y axis direction can be used for a thin apparatus such as a flat TV since it is used as a heat pipe linking the CPU and the fin arranged next to each other.

What is claimed is:

1. A heat radiating material consisting of a mixed graphite having a mixture of a filler and a foamed graphite, and a 10-100 micrometer thick sheet body,
wherein the foamed graphite accounts for 70-95% of the entire mixed graphite, and
wherein the mixed graphite and the sheet body are laminated.

2. The heat radiating material according to claim 1, wherein said sheet body is a polyester sheet.

3. The heat radiating material according to claim 1, wherein said sheet body is an aluminum foil.

4. The heat radiating material according to claim 1, wherein said filler is one or more kinds of thermally conductive fillers selected from a group consisting of artificial graphite, boron nitride, and milled pitch based carbon fiber.

5. The heat radiating material according to claim 2, wherein said filler is one or more kinds of thermally conductive fillers selected from a group consisting of artificial graphite, boron nitride, and milled pitch based carbon fiber.

6. The heat radiating material according to claim 3, wherein said filler is one or more kinds of thermally conductive fillers selected from a group consisting of artificial graphite, boron nitride, and milled pitch based carbon fiber.

7. A heat radiating material consisting of a mixed graphite having a mixture of a filler and an foamed graphite, and a 10-100 micrometer thick sheet body,
wherein said filler is one or more kinds of thermally conductive fillers selected from a group consisting of artificial graphite, boron nitride, and milled pitch based carbon fiber,
wherein the foamed graphite accounts for 70-95% of the entire mixed graphite,
wherein the mixed graphite and the sheet body are laminated, and
wherein the heat radiating material has the thermal conductivity of 3-15 W/m·K in thickness direction and 50-250 W/m·K in plane direction.

8. The heat radiating material according to claim 7, wherein said sheet body is a polyester sheet.

9. The heat radiating material according to claim 7, wherein said sheet body is an aluminum foil.
